(19) United States
(12) Patent Application Publication
(10) Pub. No.: US 2025/0002619 A1
(43) Pub. Date: Jan. 2, 2025

(54) PVDF BINDERS FOR GRAPHITE/SILICON ANODES

(71) Applicant: SOLVAY SPECIALTY POLYMERS ITALY S.P.A., Bollate (Milano) (IT)

(72) Inventors: Julio A. Abusleme, Saronno (IT); Maurizio Biso, Milano (IT); Ricardo Rino Pieri, Milano (IT)

(73) Assignee: SOLVAY SPECIALTY POLYMERS ITALY S.P.A., Bollate (Milano) (IT)

(21) Appl. No.: 18/799,879

(22) Filed: Aug. 9, 2024

Related U.S. Application Data
(63) Continuation of application No. 16/762,915, filed on May 8, 2020.

(30) Foreign Application Priority Data
Nov. 24, 2017 (EP) 17203437.3

(51) Int. Cl. C08F 14/22; C08F 14/24; C08F 14/26; C08F 14/28; C08F 20/06; H01M 4/02; H01M 4/38; H01M 4/583; H01M 4/62

(52) U.S. Cl. CPC C08F 14/22; C08F 14/24; C08F 14/26; C08F 14/28; C08F 20/06; H01M 4/386; H01M 4/583; H01M 4/623; H01M 2004/027

(57) ABSTRACT

The present invention pertains to vinylidene fluoride copolymers comprising recurring units derived from hydrophilic (meth)acrylic monomers and from perhalogenated monomers and to their use as binders for silicon negative electrodes.

### CROSS-REFERENCE TO RELATED APPLICATIONS

This application claims benefit of U.S. application Ser. No. 16/762,915 filed on May 8, 2020, which is a national stage entry of International Application No. PCT/EP2018/082151 filed Nov. 22, 2018 that claims priority to European application No. 17203437.3 filed on Nov. 24, 2017. The entire contents of these applications are incorporated herein by reference for all purposes.

### TECHNICAL FIELD

The present invention pertains to vinylidene fluoride copolymers comprising recurring units derived from hydrophilic (meth)acrylic monomers and from perhalogenated monomers and to their use as binders for silicon negative electrodes.

### BACKGROUND ART

Lithium-ion batteries (LIBs) have been applied in a variety of portable electronic devices and are being pursued as power sources for hybrid electric and electric vehicles. To meet the requirements of large-scale applications, LIBs with improved energy density and power capacity are desirable.

Nowadays, the trend in lithium batteries is to enhance their energy capacity by increasing the lithium storage in the anode. For this reason, the conventional graphite anodes enriched with silicon have attracted tremendous interest due to their much higher theoretical energy capacity.

Silicon (Si) has a high capacity (gravimetric capacity of 3572 mAh g⁻¹ and volumetric capacity of 8322 mAh cm⁻³ for Li_{3.75}Si at room temperature) and low charge-discharge potential (delithiation voltage of around 0.4 V). Unfortunately, silicon also suffers from an extremely large volume change (>400%) (an anisotropic volume expansion) that occurs during lithium ion alloying.

The volume change leads to a number of disadvantages. For example, it may cause severe pulverization and break electrical contact between Si particles and carbon conducting agents. It may also cause unstable solid electrolyte interphase (SEI) formation, resulting in degradation of electrodes and rapid capacity fading, especially at high current densities.

For the above mentioned reasons, electrode formulations for silicon anodes comprise at most 20% by weight of silicon compounds, the remaining being graphite. In particular, electrode formulations comprising graphite and an amount by weight of silicon compounds from 5% and up to 20% are being investigated.

Moreover, particular attention has been devoted to developing binders that can inhibit the severe volume change for silicon anodes. The most conventional binder (poly(vinylidene fluoride), denoted as “PVDF”) used for the batteries is attached to silicon particles via weak van der Waals forces only, and fails to accommodate large changes in spacing between the particles.

Polymer binders containing carboxy groups such as polyacrylic acid (PAA) and carboxymethyl cellulose (CMC) have been reported to perform better than PVDF, but unfortunately the performance of said binders is not good enough.

One aim of the present invention is to provide a polymer binder that can be efficiently used as binder for silicon anodes.

### SUMMARY OF INVENTION

It has been now surprisingly found that certain VDF copolymers characterized by a high molecular weight are endowed with good adhesion to metal substrates and can improve the cycling performances when used as binder for the preparation of silicon electrodes in Li-ion batteries.

Therefore, an object of the present invention is an electrode-forming composition [composition (C)] comprising:
(i) a linear semi-crystalline VDF copolymer [polymer (F)] comprising:
   a) recurring units derived from vinylidene fluoride (VDF) monomer,
   b) recurring units derived from at least one hydrophilic (meth)acrylic monomer (MA) of formula (I):

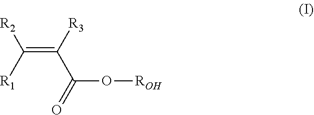

wherein:
   R₁, R₂ and R₃, equal to or different from each other, are independently selected from a hydrogen atom and a C₁-C₃ hydrocarbon group, and
   R_{OH} is a hydrogen atom or a C₁-C₅ hydrocarbon moiety comprising at least one hydroxyl group,
in an amount of from 0.05% to 2.5% by moles, preferably from 0.1 to 2.0% by moles, more preferably from 0.2 to 1.0% by moles, with respect to the total amount of moles of recurring units in said polymer (F), and
   c) recurring units derived from at least one perhalogenated monomer (FM) in an amount of 0.1% to 5.0% by moles, preferably from 0.5 to 3.0% by moles, with respect to the total amount of moles of recurring units in said polymer (F),
said polymer (F) having an intrinsic viscosity measured in dimethylformamide at 25° C. higher than 0.25 l/g, preferably higher than 0.30 l/g, more preferably higher than 0.35 l/g;
(ii) a powdery electrode material comprising at least one silicon material; and
(iii) optionally, an electroconductivity-imparting additive and/or a viscosity modifying agent.

In another object, the present invention pertains to the use of the electrode-forming composition (C) for the manufacture of a silicon negative electrode [electrode (E)], said process comprising:
(i) providing a metal substrate having at least one surface;
(ii) providing an electrode-forming composition [composition (C)] as above defined;
(iii) applying the composition (C) provided in step (ii) onto the at least one surface of the metal substrate provided in step (i), thereby providing an assembly comprising a metal substrate coated with said composition (C) onto the at least one surface;
(iv) drying the assembly provided in step (iii);
(v) submitting the dried assembly obtained in step (iv) to a compression step to obtain the electrode (E) of the invention.

In a further object, the present invention pertains to the silicon negative electrode [electrode (E)] obtainable by the process of the invention.

In still a further object, the present invention pertains to an electrochemical device comprising the silicon negative electrode (E) of the present invention.

### DESCRIPTION OF EMBODIMENTS

The term “semi-crystalline” is intended to denote a polymer having a heat of fusion of more than 1 J/g when measured by Differential Scanning Calorimetry (DSC) at a heating rate of 10° C./min, according to ASTM D 3418, more preferably of at least 8 J/g. As used herein, the terms “adheres” and “adhesion” indicate that two layers are permanently attached to each other via their surfaces of contact.

The binder composition of the invention successfully provides for silicon negative electrodes having excellent adhesion to the metal collector without the use of additional adhesives.

Moreover, the Applicant has found that the electrodes of the present invention are able to improve the cycling performances after several cycles (low fading), and have a higher energy capacity than the electrodes prepared by using conventional binders comprising PVDF, carboxy groups such as polyacrylic acid (PAA) and carboxymethyl cellulose (CMC).

By the term “recurring unit derived from vinylidene difluoride” (also generally indicated as vinylidene fluoride 1,1-difluoroethylene, VDF), it is intended to denote a recurring unit of formula (I):

CF₂═CH₂.

Non-limitative examples of hydrophilic (meth)acrylic monomers (MA) of formula (I)

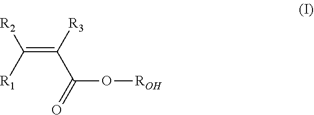

include, notably:
   acrylic acid (AA)
   (meth)acrylic acid,
   hydroxyethyl(meth)acrylate (HEA),
   2-hydroxypropyl acrylate (HPA),
   hydroxyethylhexyl(meth)acrylate,
and mixtures thereof.

The term “at least one hydrophilic (meth)acrylic monomer (MA)” is understood to mean that the polymer (F) may comprise recurring units derived from one or more than one hydrophilic (meth)acrylic monomer (MA) as above described. In the rest of the text, the expressions “hydrophilic (meth)acrylic monomer (MA)” and “monomer (MA)” are understood, for the purposes of the present invention, both in the plural and the singular, that is to say that they denote both one or more than one hydrophilic (meth)acrylic monomer (MA).

The hydrophilic (meth)acrylic monomer (MA) preferably complies with formula (II) here below:

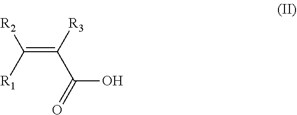

wherein each of R₁, R₂ and R₃, equal to or different from each other, is independently a hydrogen atom or a C₁-C₃ hydrocarbon group.

Still more preferably, the hydrophilic (meth)acrylic monomer (MA) is acrylic acid (AA).

Determination of the amount of monomer (MA) recurring units in polymer (F) can be performed by any suitable method. Mention can be notably made of acid-base titration methods, well suited e.g. for the determination of the acrylic acid content, of NMR methods, adequate for the quantification of (MA) monomers comprising aliphatic hydrogens in side chains (e.g. HPA, HEA), of weight balance based on total fed (MA) monomer and unreacted residual (MA) monomer during polymer (A) manufacture.

By the term “perhalogenated monomer (FM)” it is intended to denote a recurring unit being free of hydrogen atoms.

In the rest of the text, the expression “perhalogenated monomer” is understood, for the purposes of the present invention, both in the plural and the singular, that is to say that they denote both one or more than one halogenated monomers as defined above.

In a preferred embodiment, the perhalogenated monomer is selected from the group consisting of chlorotrifluoroethylene (CTFE), hexafluoropropylene (HFP) and tetrafluoroethylene (TFE).

More preferably, the perhalogenated monomer is a perfluorinated monomer, selected from HFP and TFE.

The at least one perhalogenated monomer (FM) is preferably HFP.

The inventors have found that best results are obtained when the polymer (F) is a linear semi-crystalline co-polymer.

The term “linear” is intended to denote a co-polymer made of substantially linear sequences of recurring units from (VDF) monomer, (meth)acrylic monomer and perhalogenated monomer (FM); polymer (F) is thus distinguishable from grafted and/or comb-like polymers.

The inventors have found that a substantially random distribution of monomer (MA) and monomer (FM) within the polyvinylidene fluoride backbone of polymer (F) advantageously maximizes the effects of the monomer (MA) and of monomer (FM) on adhesiveness and flex life of the resulting copolymer, without impairing the other outstanding properties of the vinylidene fluoride polymers, e.g. thermal stability and mechanical properties.

The polymer (F) is typically obtainable by emulsion polymerization or suspension polymerization of at least one VDF monomer, at least one hydrogenated (meth)acrylic monomer (MA) and at least one perhalogenated monomer (FM), according to the procedures described, for example, in WO 2007/006645 and in WO 2007/006646.

In a preferred embodiment of the invention, in polymer (F) the hydrophilic (meth)acrylic monomer (MA) of formula (I) is comprised in an amount of from 0.2 to 1.0% by moles with respect to the total moles of recurring units of polymer (F), and the at least one perhalogenated monomer (FM) is comprised in an amount of from 0.5 to 3.0% mole with respect to the total moles of recurring units of polymer (F).

More preferably, the hydrophilic (meth)acrylic monomer (MA) is a hydrophilic (meth)acrylic monomer of formula (II), still more preferably it is acrylic acid (AA), and the perhalogenated monomer (FM) is HFP, and polymer (F) is a VDF-AA-HFP terpolymer.

Polymer (F) is typically provided in the form of powder.

Preferably, the intrinsic viscosity of polymer (F), measured in dimethylformamide at 25° C., is lower than 0.70 l/g, preferably lower than 0.60 l/g, more preferably lower than 0.50 l/g.

In a preferred embodiment of the invention, the intrinsic viscosity of polymer (F), measured in dimethylformamide at 25° C., is comprised between 0.35 l/g and 0.45 l/g.

The linear semi-crystalline polymer (F) as above detailed may be used as binder for silicon electrodes in Li-ion batteries.

Composition (C) may be prepared starting from a solution of polymer (F) (binder solution of polymer (F)).

The binder solution of polymer (F) is prepared by dissolving polymer (F) in an organic solvent.

The organic solvent used for dissolving the polymer (F) to provide the binder solution may preferably be a polar one, examples of which may include: N-methyl-2-pyrrolidone, N,N-dimethylformamide, N,N-dimethylacetamide, dimethylsulfoxide, hexamethylphosphamide, dioxane, tetrahydrofuran, tetramethylurea, triethyl phosphate, and trimethyl phosphate. As the vinylidene fluoride polymer used in the present invention has a much larger polymerization degree than a conventional one, it is further preferred to use a nitrogen-containing organic solvent having a larger dissolving power, such as N-methyl-2-pyrrolidone, N,N-dimethylformamide or N,N-dimethylacetamide among the above-mentioned organic solvents. These organic solvents may be used singly or in mixture of two or more species.

For obtaining the binder solution of polymer (F) as above detailed, it is preferred to dissolve 0.1-10 wt. parts, particularly 1-5 wt. parts, of the copolymer (F) in 100 wt. parts of such an organic solvent. Below 0.1 wt. part, the polymer occupies too small a proportion in the solution, thus being liable to fail in exhibiting its performance of binding the powdery electrode material. Above 10 wt. parts, an abnormally high viscosity of the solution is obtained, so that not only the preparation of the electrode-forming composition becomes difficult but also avoiding gelling phenomena can be an issue.

In order to prepare the polymer (F) binder solution, it is preferred to dissolve the copolymer (F) in an organic solvent at an elevated temperature of 30-200° C., more preferably 40-160° C., further preferably 50-150° C. Below 30° C., the dissolution requires a long time and a uniform dissolution becomes difficult.

An electrode-forming composition [composition (C)] may be obtained by adding and dispersing a powdery electrode material comprising at least one silicon material and optional additives, such as an electroconductivity-imparting additive and/or a viscosity modifying agent, into the polymer (F) binder solution as above defined, and possibly by diluting the resulting composition with additional solvent.

The powdery electrode material comprising at least one silicon material suitably comprises a carbon-based material and a silicon-based compound.

In the present invention, the carbon-based material may be, for example, graphite, such as natural or artificial graphite, or carbon black. These materials may be used alone or as a mixture of two or more thereof. The carbon-based material may be particularly graphite.

The silicon-based compound may be one or more selected from the group consisting of chlorosilane, alkoxysilane, aminosilane, fluoroalkylsilane, silicon, silicon chloride, silicon carbide and silicon oxide. More particularly, the silicon-based compound may be silicon oxide or silicon carbide.

The at least one silicon-based compound is comprised in the powdery electrode material in an amount ranging from 1 to 30% by weight, preferably from 5 to 20% by weight with respect to the total weight of the powdery electrode material.

An electroconductivity-imparting additive may be added in order to improve the conductivity of a resultant composite electrode layer formed by applying and drying of the electrode-forming composition of the present invention, particularly in case of using an active substance, such as LiCoO₂ or LiFePO₄, showing a limited electron-conductivity. Examples thereof may include: carbonaceous materials, such as carbon black, graphite fine powder and fiber, and fine powder and fiber of metals, such as nickel and aluminum.

The amount of polymer (F) in the electrode formulation depends on the properties of the carbon-based material and of the silicon-based compound used in the powdery electrode material.

The electrode-forming composition (C) of the invention can be used in a process for the manufacture of a silicon negative electrode [electrode (E)], said process comprising:
(i) providing a metal substrate having at least one surface;
(ii) providing an electrode-forming composition [composition (C)] as above defined;
(iii) applying the composition (C) provided in step (ii) onto the at least one surface of the metal substrate provided in step (i), thereby providing an assembly comprising a metal substrate coated with said composition (C) onto the at least one surface;
(iv) drying the assembly provided in step (iii);
(v) submitting the dried assembly obtained in step (iv) to a compression step to obtain the electrode (E) of the invention.

The metal substrate is generally a foil, mesh or net made from a metal, such as copper, aluminium, iron, stainless steel, nickel, titanium or silver.

Under step (iii) of the process of the invention, the composition (C) is applied onto at least one surface of the metal substrate typically by any suitable procedures such as casting, printing and roll coating.

Optionally, step (iii) may be repeated, typically one or more times, by applying the composition (2) provided in step (ii) onto the assembly provided in step (iv).

Under step (v), the dried assembly obtained at step (iv) is subjected to a compression step, such as a calendering process, to achieve the target porosity and density of the electrode (E).

Preferably, the dried assembly obtained at step (iv) is hot pressed, the temperature during the compression step being comprised from 25° C. and 130° C., preferably being of about 60° C.

Preferred target porosity for electrode (E) is comprised between 15% and 40%, preferably from 25% and 30%. The porosity of electrode (E) is calculated as the complementary to unity of the ratio between the measured density and the theoretical density of the electrode, wherein:
the measured density is given by the mass divided by the volume of a circular portion of electrode having diameter equal to 24 mm and a measured thickness; and
the theoretical density of the electrode is calculated as the sum of the product of the densities of the components of the electrode multiplied by their mass ratio in the electrode formulation.

In a further instance, the present invention pertains to the silicon negative electrode [electrode (E)] obtainable by the process of the invention.

The silicon negative electrode (E) generally comprises:
graphite in an amount by weight of from 75% to 95%, preferably from 85% to 90%;
at least one silicon compound in an amount by weigh of from 3% to 20%, preferably of from 5% to 10%;
an electroconductivity-imparting additive in an amount by weight of from 0% to 5%, preferably from 0.5% to 2.5%, more preferably of about 1%;
polymer (F) in an amount by weight of from 1% to 15%, preferably from 5% to 10%;
the percentages by weight being indicated with respect to the total weight of the electrode (E).

In one preferred embodiment, the silicon negative electrode (E) comprises
graphite in an amount by weight of about 89%;
silicon oxide in amount by weigh of about 5%;
an electroconductivity-imparting additive in an amount by weight of about 1%;
polymer (F) in an amount by weight of about 5%;
the percentages by weight being indicated with respect to the total weight of the electrode (E).

The Applicant has surprisingly found that the silicon negative electrode (E) of the present invention shows good adhesion of the binder to current collector, better capacity retention and better capacity towards conventional silicon negative electrode binders.

The silicon negative electrode (E) of the invention is particularly suitable for use in electrochemical devices, in particular in secondary batteries.

The secondary battery of the invention is preferably an alkaline or an alkaline-earth secondary battery.

The secondary battery of the invention is more preferably a lithium-ion secondary battery.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### Experimental Part

### Raw Materials

Graphite, commercially available as Actilion 2 from Imerys S.A.;
Silicon oxide, commercially available as CRZ113 from Hitachi Chemicals;
Carbon black, commercially available as SC45 from Imerys S.A.;
Carboxymethylcellulose (CMC), commercially available as MAC 500LC from Nippon Paper;
SBR suspension 40% by weight in water, commercially available as Zeon® BM-480B from ZEON Corporation;
PAA aqueous solution (35% w/w) commercially available from Sigma Aldrich;
NMP commercially available from Sigma Aldrich;
Polymer (A): VDF-AA (0.6% by moles)-HFP (0.8% by moles) polymer having an intrinsic viscosity of 0.38 l/g in DMF at 25° C.
Polymer (B-Comp): VDF-AA (0.9% by moles) polymer having an intrinsic viscosity of 0.30 l/g in DMF at 25° C., prepared as described in WO 2008/129041.
Polymer (C): VDF-AA (0.7% by moles)-HFP (2.3% by moles) polymer having an intrinsic viscosity of 0.31 l/g in DMF at 25° C.
Polymer (D-Comp): VDF-AA (0.6% by moles) polymer having an intrinsic viscosity of 0.38 l/g in DMF at 25° C., prepared as described in WO 2008/129041.

### Preparation of Polymer (A)

In a 80 litres reactor equipped with an impeller running at a speed of 250 rpm were introduced, in sequence, 24.5 Kg of demineralised and 0.6 g/kgMnT of hydroxyethylcellulose derivative (suspending agent, commercially available as Bermocoll® E 230 FQ from AkzoNobel), wherein g/MnT means grams of product per Kg of the total amount of the comonomers (HFP, AA and VDF) introduced during the polymerization. The reactor was purged with sequence of vacuum (30 mmHg) and purged of nitrogen at 20° C. Then 2.65 g/kgMnT of a 75% by weight solution of t-amyl-perpivalate in isododecane (initiator agent, commercially available from Arkema) was added. The speed of the stirring was increased at 300 rpm. Finally, 8.5 g of acrylic acid (AA) and 0.85 Kg of hexafluoropropylene (HFP) were introduced in the reactor, followed by 24.5 Kg of vinylidene fluoride (VDF).

The reactor was gradually heated until the set-point temperature at 50° C. and the pressure was fixed at 120 bar. The pressure was kept constantly equal to 120 bar by feeding 204 g of AA diluted in an aqueous solution (concentration of AA of 12.5 g/Kg water). After this feeding, no more aqueous solution was introduced and the pressure started to decrease. Then, the polymerization was stopped by degassing the reactor until reaching atmospheric pressure. In general a conversion between around 74% and 85% of comonomers was obtained. The polymer so obtained was then recovered, washed with demineralised water and oven-dried at 65° C.

### Preparation of Polymer (C)

In a 80 litres reactor equipped with an impeller running at a speed of 250 rpm were introduced, in sequence, 50.4 Kg of demineralised and 0.6 g/kgMnT of hydroxyethylcellulose derivative (suspending agent, commercially available as Bermocoll® E 230 FQ from AkzoNobel), wherein g/MnT means grams of product per Kg of the total amount of the comonomers (HFP, AA and VDF) introduced during the polymerization. The reactor was purged with sequence of vacuum (30 mmHg) and purged of nitrogen at 20° C. Then 3.0 g/kgMnT of a 75% by weight solution of t-amyl-perpivalate in isododecane (initiator agent, commercially available from Arkema) was added. The speed of the stirring was increased at 300 rpm. Finally, 21.6 g of acrylic acid (AA) and 2.5 Kg of hexafluoropropylene (HFP) were introduced in the reactor, followed by 22.7 Kg of vinylidene fluoride (VDF).

The reactor was gradually heated until the set-point temperature at 52° C. and the pressure was fixed at 120 bar. The pressure was kept constantly equal to 120 bar by feeding 234 g of AA diluted in an aqueous solution (concentration of AA of 14 g/Kg water). After this feeding, no more aqueous solution was introduced and the pressure started to decrease. Then, the polymerization was stopped by degassing the reactor until reaching atmospheric pressure. In general a conversion between around 74% and 85% of comonomers was obtained. The polymer so obtained was then recovered, washed with demineralised water and oven-dried at 65° C.

### Determination of Intrinsic Viscosity of Polymer (F)

Intrinsic viscosity (η) [l/g] of the polymers of the examples was measured using the following equation on the basis of dropping time, at 25° C., of a solution obtained by dissolving the polymer (F) in N,N-dimethylformamide at a concentration of about 0.2 g/dl using a Ubbelhode viscosimeter:

$$[ η ] = \frac{{η}_{sp} + Γ \cdot ln {η}_{r}}{( 1 + Γ ) \cdot c}$$

where c is polymer concentration [g/l], ηᵣ is the relative viscosity, i.e. the ratio between the dropping time of sample solution and the dropping time of solvent, ηₛₚ is the specific viscosity, i.e. ηᵣ−1, and Γ is an experimental factor, which for polymer (F) corresponds to 3.

### General Procedure for the Manufacture of Negative Electrodes

Negative electrodes were prepared by mixing the components as detailed below by using the following equipment:
mechanical mixer: planetary mixer (Speedmixer) and mechanical mixer of the Dispermat® series with flat PTFE lightweight dispersion impeller (for good mixing dispersion state),
film coater/Doctor Blade: Elcometer 4340 Motorised/Automatic Film Applicator,
vacuum oven: vacuum drying oven-BINDER APT line VD 53 with vacuum,
roll press: Precision 4″ Hot Rolling Press/Calender up to 100° C.

### Example 1: Negative Electrode According to the Invention

An NMP composition was prepared by mixing 16.67 g of a 6% by weight solution of Polymer (A) in NMP, 4.33 g of NMP, 17.86 g of graphite, 0.94 g of silicon oxide and 0.2 g of carbon black.

The mixture was homogenized by moderate stirring in planetary mixer for 10′ and then mixed again by moderate stirring for 2h giving the electrode-forming composition (C1).

A negative electrode was obtained by casting the electrode-forming composition (C1) so obtained on a 20 μm thick copper foil with a doctor blade and drying the coating layer so obtained in an oven at temperature ramp from 80° C. to 130° C. for about 60 minutes.

The thickness of the dried coating layer was about 90 μm.

The electrode was then hot pressed at 90° C. in a roll press to achieve the target porosity (30%).

The negative electrode so obtained (electrode (E1)) had the following composition: 89.3% by weight of graphite, 5% by weight of polymer (A), 4.7% by weight of silicon oxide and 1% by weight of carbon black.

### Example 2: Comparative Negative Electrode

An NMP composition was prepared by mixing 16.67 g of a 6% by weight solution of Polymer (B-Comp) in NMP, 4.33 g of NMP, 17.86 g of graphite, 0.94 g of silicon oxide and 0.2 g of carbon black.

The mixture was homogenized by moderate stirring in planetary mixer for 10′ and then mixed again by moderate stirring for 2 h giving the electrode-forming composition (C2-Comp).

A negative electrode was obtained by casting the electrode-forming composition (C2-Comp) so obtained on a 20 μm thick copper foil with a doctor blade and drying the coating layer so obtained in an oven at temperature ramp from 80° C. to 130° C. for about 60 minutes.

The thickness of the dried coating layer was about 90 μm.

The electrode was then hot pressed at 90° C. in a roll press to achieve the target porosity (30%).

The negative electrode so obtained (electrode (E2-Comp)) had the following composition: 89.3% by weight of graphite, 5% by weight of polymer (B-Comp), 4.7% by weight of silicon oxide and 1% by weight of carbon black.

### Example 3: Negative Electrode According to the Invention

An NMP composition was prepared by mixing 16.67 g of a 6% by weight solution of Polymer (C) in NMP, 4.33 g of NMP, 17.86 g of graphite, 0.94 g of silicon oxide and 0.2 g of carbon black.

The mixture was homogenized by moderate stirring in planetary mixer for 10′ and then mixed again by moderate stirring for 2 h giving the electrode-forming composition (C3).

A negative electrode was obtained by casting the electrode-forming composition (C3) so obtained on a 20 μm thick copper foil with a doctor blade and drying the coating layer so obtained in an oven at temperature ramp from 80° C. to 130° C. for about 60 minutes.

The thickness of the dried coating layer was about 90 μm.

The electrode was then hot pressed at 90° C. in a roll press to achieve the target porosity (30%).

The negative electrode so obtained (electrode (E3)) had the following composition: 89.3% by weight of graphite, 5% by weight of Polymer (C), 4.7% by weight of silicon oxide and 1% by weight of carbon black.

### Example 4: Comparative Negative Electrode

An NMP composition was prepared by mixing 16.67 g of a 6% by weight solution of Polymer (D-Comp) in NMP, 4.33 g of NMP, 17.86 g of graphite, 0.94 g of silicon oxide and 0.2 g of carbon black.

The mixture was homogenized by moderate stirring in planetary mixer for 10′ and then mixed again by moderate stirring for 2 h giving the electrode-forming composition (C4-Comp).

A negative electrode was obtained by casting the electrode-forming composition (C4-Comp) so obtained on a 20 μm thick copper foil with a doctor blade and drying the coating layer so obtained in an oven at temperature ramp from 80° C. to 130° C. for about 60 minutes.

The thickness of the dried coating layer was about 90 μm.

The electrode was then hot pressed at 90° C. in a roll press to achieve the target porosity (30%).

The negative electrode so obtained (electrode (E4-Comp)) had the following composition: 89.3% by weight of graphite, 5% by weight of Polymer (D-Comp), 4.7% by weight of silicon oxide and 1% by weight of carbon black.

### Example 5: Comparative Negative Electrode (SBR/CMC)

An aqueous composition was prepared by mixing 29.05 g of a 2% by weight solution of CMC, in water, 4.76 g of deionized water, 31.25 g of graphite, 1.65 g of silicon oxide and 0.35 g of carbon black.

The mixture was homogenized by moderate stirring.

After about 1 h of mixing, 2.94 g of SBR suspension was added to the composition and mixed again at low stirring for 1 h, giving the electrode-forming composition (C5-Comp).

A negative electrode was obtained casting the electrode-forming composition (C5-Comp) so obtained on a 20 μm thick copper foil with a doctor blade and drying the coating layer so obtained in an oven at temperature of 60° C. for about 60 minutes.

The thickness of the dried coating layer was about 90 μm.

The electrode was then hot pressed at 60° C. in a roll press to achieve target porosity (30%).

The negative electrode so obtained (electrode (E5-Comp)) had the following composition: 89.3% by weight of graphite, 1.66% by weight of CMC, 3.33% by weight of SBR, 4.7% by weight of silicon oxide and 1% by weight of carbon black.

### Example 6: Comparative Negative Electrode (PAA)

An aqueous composition was prepared by mixing 5.71 g of a PAA aqueous solution (35% w/w), 36.3 g of deionized water, 35.72 g of graphite, 1.88 g of silicon oxide and 0.4 g of carbon black.

The mixture was homogenized by moderate stirring in planetary mixer for 10′ and then mixed again by moderate stirring for 2 h giving the electrode-forming composition (C6-Comp).

A negative electrode was obtained casting the electrode-forming composition (C6-Comp) so obtained on a 20 μm thick copper foil with a doctor blade and drying the coating layer so obtained in an oven at temperature of 60° C. for about 60 minutes.

The thickness of the dried coating layer was about 90 μm.

The electrode was then hot pressed at 60° C. in a roll press to achieve target porosity (30%).

The negative electrode so obtained (electrode (E6-Comp)) had the following composition: 89.3% by weight of graphite, 5% by weight of PAA, 4.7% by weight of silicon oxide and 1% by weight of carbon black.

### Adhesion Properties Measurement on the Negative Electrodes

Peeling tests were performed on electrode (E1), electrode (E2-Comp), electrode (E3), electrode (E4-Comp), electrode (E5-Comp) and electrode (E6-Comp) by following the standard ASTM D903 at a speed of 300 mm/min at 20° C. in order to evaluate the adhesion of the electrode composition coating on the metal foil.

The results are shown in Table 1.

TABLE 1

| | Adhesion | STD |
|---|---|---|
| Electrode | (N/m) | DEV |
| E1 | 171 | 8 |
| E2-Comp | 104 | 6 |
| E4-Comp | 115 | 11 |
| E5-Comp | 61 | 10 |
| E6-Comp | 2.2 | 0.3 |

The results show that electrode (E1) according to the present invention has outstanding values of adhesion to the copper current collector, in comparison with that of the electrodes (E2-Comp), (E4-Comp), (E5-Comp) and (E6-Comp).

### Manufacture of Batteries

A positive electrode using Lithium cobalt oxide as active material (LCO, commercially available from MTI, having the following composition 95.7% by weight of LCO, 2% by weight of PVDF binder and 2.3% by weight of carbon) has been used as cathode.

The positive electrode has a capacity of 1.8 mAh/cm².

Full coin cells (CR2032) were prepared in a glove box under Ar gas atmosphere by punching a small disk of the negative electrode (E1) or electrode (E2-Comp) or electrode (E3) or electrode (E4-Comp) or electrode (E5-Comp) or electrode (E6-Comp) obtained in examples 1 to 6, respectively, as negative electrodes, and a positive electrode as above described. The electrolyte used in the preparation of the coin cells was a standard 1M LiPF₆ in the binary solvents of EC:DMC=1:1 in % by weight, commercially available from BASF as LP30, with 2% by weight of VC and 10% by weight of F1EC as additive; polyethylene separators (commercially available from Tonen Chemical Corporation) were used as received.

After initial charge and discharge cycles at low current rate, cells were galvanostatically cycled at a constant current rate of 0.2 C to show capacity fade over cycling. The results are shown in Table 2.

TABLE 2

| | | Capacity retention | | Capacity retention | |
|---|---|---|---|---|---|
| | | after 25 cycles | | after 100 cycles | |
| | Initial | | % of the | | % of the |
| | discharge | | initial | | initial |
| | (mAh/g) | (mAh/g) | capacity | (mAh/g) | capacity |
| E1 | 106 | 84 | 77 | 71 | 65 |
| E2-Comp | 111 | 69 | 64 | 45 | 41 |
| E3 | 113 | 86 | 75 | 71 | 62 |
| E4-Comp | 112 | 76 | 68 | 49 | 44 |
| E5-Comp | 116 | 78 | 70 | 56 | 50 |
| E6-Comp | 119 | 76 | 64 | 24 | 20 |

It has been found that higher capacity is maintained for the coin cell comprising the negative electrode of the invention, as notably embodied by electrodes (E1) and (E3) in comparison with those comprising the comparative electrodes (E2-Comp), (E4-Comp), (E5-Comp) and (E6-Comp).

Without wishing to be bound to any theory, the inventors believe that the higher intrinsic viscosity, in combination with the presence of certain amounts of at least one hydrophilic (meth)acrylic monomer (MA) and of at least one perhalogenated monomer (FM), are responsible for the improved capacity of electrodes including PVDF binders.

In view of the above, it has been found that the polymer (F) of the present invention and any electrodes prepared thereof is particularly suitable for use in the preparation of binders for silicon negative electrodes for use in secondary batteries having improved performance.

1. An electrode-forming composition [composition (C)] comprising:
(i) a polymer (F), wherein polymer (F) is a linear semi-crystalline VDF copolymer comprising:
a) recurring units derived from vinylidene fluoride (VDF) monomer,
b) recurring units derived from at least one hydrophilic (meth)acrylic monomer (MA) of formula (I): 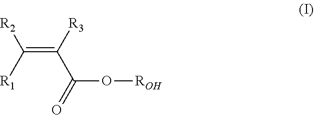
wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group,
in an amount of from 0.2% to 1.0% by moles, with respect to the total amount of moles of recurring units in said polymer (F), and
c) recurring units derived from at least one perhalogenated monomer (FM) selected from the group consisting of chlorotrifluoroethylene (CTFE), hexafluoropropylene (HFP) and tetrafluoroethylene (TFE) in an amount of 0.1% to 5.0% by moles, with respect to the total amount of moles of recurring units in said polymer (F),
said polymer (F) having an intrinsic viscosity measured in dimethylformamide at 25° C. greater than 0.35 l/g;
(ii) a powdery electrode material comprising at least one silicon material, wherein the at least one silicon material is comprised in the powdery electrode material in an amount ranging from 5 to 20% by weight, with respect to the total weight of the powdery electrode material; and
(iii) optionally, an electroconductivity-imparting additive and/or a viscosity modifying agent.

2. The composition (C) according to claim 1, wherein the at least one hydrophilic (meth)acrylic monomers (MA) of formula (I) is selected from the group consisting of acrylic acid (AA), (meth)acrylic acid, hydroxyethyl(meth)acrylate (HEA), 2-hydroxypropyl acrylate (HPA), hydroxyethylhexyl(meth)acrylate, and mixtures thereof.

3. The composition (C) according to claim 1, wherein the hydrophilic (meth)acrylic monomer (MA) is a hydrophilic (meth)acrylic monomer of formula (II):

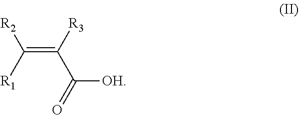

4. The composition (C) according to claim 1, wherein polymer (F) has intrinsic viscosity, measured in dimethylformamide at 25° C., lower than 0.70 l/g.

5. The composition (C) according to claim 1, wherein the at least one hydrophilic (meth)acrylic monomer (MA) is comprised in an amount of from 0.2 to 1.0 mole % with respect to the total moles of recurring units of polymer (F), and the at least one perhalogenated monomer (FM) is comprised in an amount of from 0.5 to 3.0% mole with respect to the total moles of recurring units of polymer (F).

6. The composition (C) according to claim 1, wherein the powdery electrode material comprising at least one silicon material comprises a carbon-based material and a silicon-based compound.

7. The composition (C) according to claim 6 wherein the carbon-based material is graphite and the silicon-based compound is selected from the group consisting of chlorosilane, alkoxysilane, aminosilane, fluoroalkylsilane, silicon, silicon chloride, silicon carbide and silicon oxide.

8. The composition (C) according to claim 6, wherein the powdery electrode material comprising at least one silicon material further comprises at least one electroconductivity-imparting additive

9. A process for the manufacture of a silicon negative electrode (E), said process comprising:
applying an electrode-forming composition (C) according to claim 1 onto at least one surface of a metal substrate having at least one surface, thereby providing an assembly comprising a metal substrate coated with said composition (C) onto the at least one surface;
drying the assembly to provide a dried assembly;
submitting the dried assembly to a compression step to obtain an electrode (E).

10. A silicon negative electrode (E) obtained by the process of claim 9.

11. The electrode (E) according to claim 10 which comprises:
graphite in an amount by weight of from 75% to 95%;
at least one silicon compound in an amount by weigh of from 3% to 20%;
an electroconductivity-imparting additive in an amount by weight of from 0% to 5%;
polymer (F) in an amount by weight of from 1% to 15%;
the percentages by weight being indicated with respect to the total weight of the electrode (E).

12. The electrode (E) according to claim 11 which comprises:
graphite in an amount by weight of about 89%;
silicon oxide in amount by weigh of about 5%;
an electroconductivity-imparting additive in an amount by weight of about 1%;
polymer (F) in an amount by weight of about 5%;
the percentages by weight being indicated with respect to the total weight of the electrode (E).

13. An electrochemical device comprising the silicon negative electrode (E) according to claim 10.

14. The electrochemical device of claim 13 that is a lithium secondary battery.

15. The composition (C) according to claim 1 wherein polymer (F) comprises:
a) the recurring units derived from vinylidene fluoride (VDF) monomer, and
b) the recurring units derived from at least one perhalogenated monomer (FM) in an amount of 0.5 to 3.0% by moles, with respect to the total amount of moles of recurring units in said polymer (F).

16. The composition (C) according to claim 1, wherein the hydrophilic (meth)acrylic monomer (MA) is acrylic acid (AA), and the perhalogenated monomer (FM) is HFP.

17. The composition (C) according to claim 4 wherein polymer (F) has intrinsic viscosity, measured in dimethylformamide at 25° C., less than 0.50 l/g.
